(19) United States
(12) Patent Application Publication
(10) Pub. No.: US 2022/0314469 A1
(43) Pub. Date: Oct. 6, 2022

(54) MULTIPURPOSE TOOL FOR REACHING OBJECTS

(71) Applicant: Miguel Flores, San Antonio, TX (US)

(72) Inventor: Miguel Flores, San Antonio, TX (US)

(21) Appl. No.: 17/706,292

(22) Filed: Mar. 28, 2022

Related U.S. Application Data
(60) Provisional application No. 63/167,582, filed on Mar. 29, 2021.

(51) Int. Cl. B26B 11/00; A47F 13/06

(52) U.S. Cl. CPC B26B 11/00; A47F 13/06

(57) ABSTRACT

A multipurpose tool includes a handle having a first end and a second end opposite of the first end. The handle is sized and shaped to fit in a hand of a user. The tool also includes an extendable member protruding from the first end of the handle and a safety cutter disposed in the second end of the handle. The extendable member has an extended configuration and a collapsed configuration. The tool is sized and shaped to fit within a pocket in an article of clothing when the extendable member is in the collapsed configuration. The extendable member has a plurality of telescoping parts and a locking mechanism for locking the telescoping parts in the extended configuration. A distal end of the extendable member includes a hook for engaging objects and pulling them towards the user.

### CROSS-REFERENCE TO RELATED APPLICATIONS

This application claims priority to U.S. Provisional Patent Application Ser. No. 63/167,582, filed Mar. 29, 2021, entitled “MULTIPURPOSE TOOL FOR REACHING OBJECTS,” the entire contents of which are incorporated herein by reference.

### BACKGROUND

### Field of the Art

This disclosure relates to a multipurpose tool configured for reaching inaccessible objects, wherein the tool further includes a safety cutter.

### Discussion of the State of the Art

Tools for reaching inaccessible items typically include a grabber or hook mechanism on the distal end of an elongate rod. These tools are useful for reaching objects that are farther than an arm's reach away. For example, these tools are useful for reaching objects that are placed on high shelves, objects that are positioned towards the rear of a deep shelf, objects that are positioned in a truck bed towards the cab of the truck and are not easily accessed by a person standing at the tailgate of the truck, or the like.

However, one problem with these reaching tools is that they are generally not easily portable and cannot fit into a user's pocket. These tools typically include a grabber mechanism on the distal end thereof, which may include pinchers, suction cups, or the like, and these mechanisms make the tool too bulky to fit in a pocket. In addition, due to the length of the tools, they do not easily fit in a pocket or purse.

Another problem with conventional reaching tools is that they only have one use, which is to reach objects that are out of arm's reach. As such, there is a need for a portable reaching tool that can be used for other functions, especially for jobs or tasks that frequently require a reaching tool.

### SUMMARY

The multipurpose tool disclosed herein includes an extendable reaching member and a safety cutter. As such, the tool is especially useful for jobs and tasks that frequently require accessing objects that are out of arm's reach and performing cutting tasks, such as cutting tape, shrink wrap, strapping, boxes, etc. For example, the multipurpose tool disclosed herein is especially useful for those that work in stores and may need to frequently reach items on high shelves or deep shelves and may also frequently need a cutting tool for opening boxes, cutting shrink wrap, and the like.

In accordance with the advantages described above, the multipurpose tool disclosed herein includes a handle, an extendable member attached to a first end of the handle, and a safety cutter disposed in the second end of the handle. The multipurpose tool has an expanded configuration, in which the extendable member is extended to its full length, and a collapsed configuration in which the extendable member is fully collapsed. The extendable member may include a plurality of telescoping parts. The handle is sized and shaped to fit within the hand of a user. When in the collapsed configuration, the multipurpose tool may be stored in a pocket in an article of clothing. For example, the multipurpose tool in the collapsed configuration may fit in a pants pocket, shirt pocket, or the like.

The multipurpose tool disclosed herein has several advantages over conventional reaching tools. One of the advantages of the multipurpose tool is that it is collapsible, portable, and small enough to fit in a pocket. Another advantage of the tool disclosed herein is that it can be used for many different tasks. In particular, the multipurpose tool can be used for reaching objects that are out of arm's reach and can also be used for cutting tape, shrink wrap, strapping, or the like in order to open a sealed box.

### BRIEF DESCRIPTION OF THE DRAWING FIGURES

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 is a side plan view of a multipurpose tool in an extended configuration in accordance with one embodiment of the present invention.

FIG. 2 is a side plan view of a multipurpose tool in a collapsed configuration in accordance with one embodiment of the present invention.

FIG. 3 is a cross-sectional view of a multipurpose tool in accordance with an embodiment of the present invention.

FIG. 4 is a perspective view of a handle of a multipurpose tool in accordance with an embodiment of the present invention.

FIG. 5 is a perspective view of a handle of a multipurpose tool in accordance with an embodiment of the present invention.

### DETAILED DESCRIPTION

Disclosed herein is a multipurpose tool having an extendable reaching member on one end of a handle and a safety cutter on the opposite end of the handle. The multipurpose tool has an extended configuration and a collapsed configuration. In the collapsed configuration, the tool is small enough to fit in a pocket for easy portability.

The invention is described by reference to various elements herein. It should be noted, however, that although the various elements of the inventive apparatus are described separately below, the elements need not necessarily be separate. The various embodiments may be interconnected and may be cut out of a singular block or mold. The variety of different ways of forming an inventive apparatus, in accordance with the disclosure herein, may be varied without departing from the scope of the invention.

Generally, one or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices and parts that are connected to each other need not be in continuous connection with each other, unless expressly specified otherwise. In addition, devices and parts that are connected with each other may be connected directly or indirectly through one or more connection means or intermediaries.

A description of an aspect with several components in connection with each other does not imply that all such components are required. To the contrary, a variety of optional components may be described to illustrate a wide variety of possible embodiments and in order to more fully illustrate one or more embodiments. Similarly, although process steps, method steps, or the like may be described in a sequential order, such processes and methods may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, or method is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Alternate implementations are included within the scope of various embodiments in which, for example, functions may be executed out of order from that shown or discussed, including substantially concurrently or in reverse order, depending on the functionality involved, as would be understood by those having ordinary skill in the art.

### Overview

The apparatus of the present invention is a multipurpose tool having an extendable reaching member coupled to one end of a handle and a safety cutter disposed in the opposite end of the handle. The tool has an extended configuration, in which the tool can be used for reaching objects that are out of arm's reach, such as objects on a high or deep shelf. The tool further has a collapsed configuration, in which the tool is small enough to fit in a pocket for easy portability. The safety cutter disposed in the handle of the tool can be used for cutting materials, such as tape, shrink wrap, strapping, cardboard, or the like.

### Apparatus

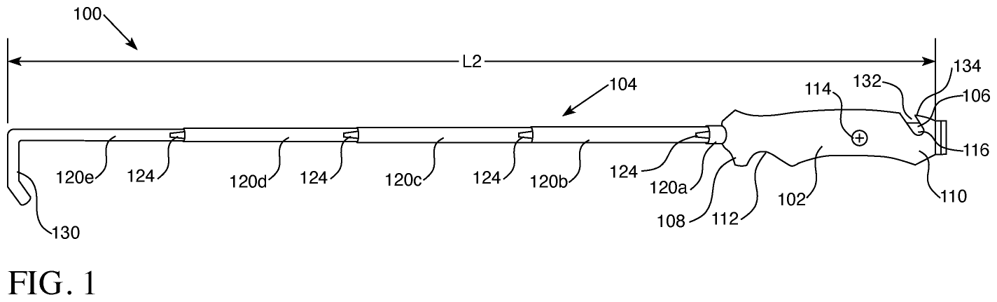

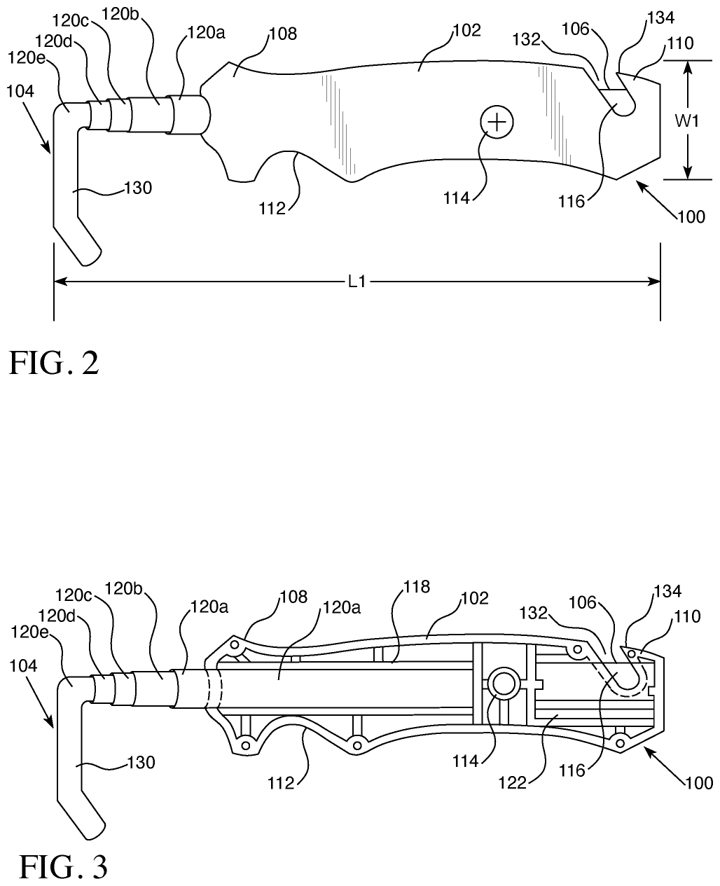

FIG. 1 illustrates the inventive apparatus 100 in accordance with an embodiment of the invention. In particular, FIG. 1 illustrates a collapsible multi-functional tool 100. The tool 100 includes a handle 102, an extendable reaching member 104, and a safety cutter 106. The tool 100 is depicted in the extended position in FIG. 1. As shown in FIG. 2, the extendable reaching member 104 retracts to a compact collapsed configuration. In the collapsed configuration, the tool 100 is small enough to fit in a pocket. For example, when the tool 100 is in the collapsed configuration shown in FIG. 2, the tool 100 is sized and shaped to fit within a pants pocket, shirt pocket, or any similar pocket in an article of clothing. As such, in the collapsed configuration, the length L1 of the tool 100 is approximately 6-9 inches, and is preferably 7-8 inches. The width W1 of the tool 100 is preferably 1-2 inches. In the extended configuration, the length L2 of the tool 100 is approximately 25-30 inches, preferably 25-28 inches, and more preferably 26-27 inches. It will be readily appreciated by one of ordinary skill in the art that the tool 100 is not limited to these dimensions and may have any desired dimensions that make the tool 100 easily portable in a purse or pocket.

The handle 102 of the tool 100 has a first end 108 and second end 110 opposite to the first end 108. The handle 102 is made of a rigid material, such as metal, plastic, wood, or the like. The outer surface of the handle 102 is contoured and includes a finger notch 112 near the first end 108 for comfortable gripping during use. The handle 102 also includes a screw 114 or similar attachment mechanism for holding the two halves of the handle 102 together. The handle 102 is easily disassembled and reassembled to facilitate replacement of a razor blade 116 in the safety cutter 106. For example, the screw 114 can be removed and the handle 102 can be disassembled to replace the razor blade 116, if necessary.

As shown in FIG. 3, the handle 102 further includes an extendable member cavity 118 at the first end 108. A proximal-most portion 120a of the extendable member 104 is disposed in the extendable member cavity 118 in a fixed manner. At the second end 110 of the handle 102 is a razor blade cavity 122 in which the razor blade 116 of the safety cutter 106 is disposed.

The extendable member 104 comprises a plurality of telescoping parts 120a, 120b, 120c, 120d, 120e that are configured to retract so that substantially the entirety of all of the parts 120b, 120c, 120d, 120e are disposed within the proximal-most portion 120a of the extendable member 104 when the extendable member 104 is in the collapsed configuration. The proximal-most portion 120a of the extendable member 104 is fixed relative to the handle 102, while the remaining portions 120b, 120c, 120d, 120e are configured to extend away from the handle 102. When the extendable member 104 is in the extended configuration, the telescoping parts 120a, 120b, 120c, 120d, 120e are configured to lock in place. As such, the extendable member 104 includes locking mechanisms 124. The extendable member 104 goes from the extended configuration to the collapsed configuration by pushing or pulling the extendable member 104 towards the handle 102. It will be readily apparent to one of ordinary skill in the art that any type of locking mechanism may be used to lock the extendable member 104 in the extended configuration. For example, the locking mechanism may be a spring-biased locking mechanism, a twist-to-lock mechanism, or the like.

The distal-most part 120e of the extendable member 104 terminates in a hook 130. In the embodiment shown in FIGS. 1-3, the distal-most part 120e of the extendable member 104 is L-shaped. The hook 130 may be used to pull an item towards the user. For example, an item that is positioned towards the rear of a high shelf may be pulled towards the front of the shelf by engaging the item with the hook 130 when the extendable member 104 is in the extended configuration and pulling the item towards the front of the shelf. It will be well understood by one of ordinary skill in the art that the hook 130 may have any desired shape, such as semi-circular, L-shaped, U-shaped, or the like.

The safety cutter 106 includes the razor blade 116 and a channel 132 that exposes the razor blade 116. The cutting channel 132 holds material in place to facilitate cutting the material. One of the edges 134 of the channel 132 has a hook or wedge shape to facilitate piercing material to be cut and to hold material in place during cutting. The safety cutter 106 may be used for cutting string, shrink wrap, strapping, cardboard, tape, or the like. The recessed razor blade 116 reduces the risk of injury and reduces the likelihood of a user being stabbed or cut when the tool 100 in the collapsed configuration is carried in the user's pocket.

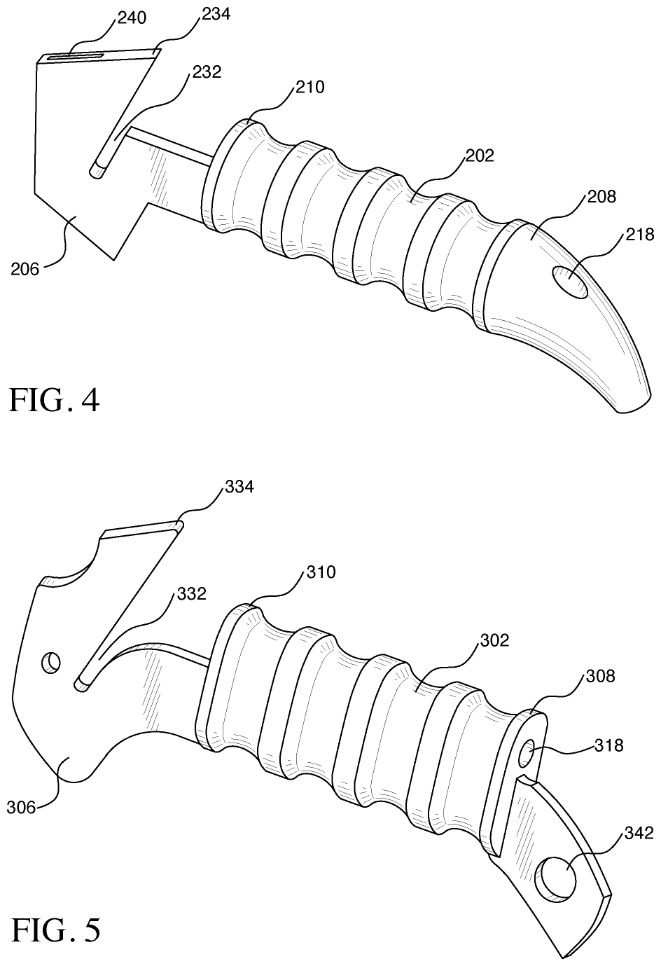

FIG. 4 depicts another example of a handle 202 for a multipurpose tool. The handle 202 has a first end 208 and a second end 210 opposite of the first end 208. The handle 202 is made of a rigid material, such as metal, plastic, wood, or the like. The outer surface of the handle 202 is contoured for comfortable gripping. The handle 202 further includes an extendable member cavity 218 at the first end 208. The extendable member cavity 218 is sized and shaped to engage with an extendable member, similar to the extendable member 104 shown in FIGS. 1-3. A proximal end of the extendable member may be disposed in, and fixedly attached to, the extendable member cavity 218. At the second end 210 of the handle 202 is a razor blade holder 206 for a recessed blade film cutter. The razor blade holder 206 includes a channel 232 that exposes the razor blade when a razor blade is disposed in the holder 206. The razor blade holder 206 further includes a pointed tip 234 for piercing material, while the recessed razor blade disposed within the channel 232 cuts the material. The material may be shrink wrap, plastic pallet strapping, corrugated cardboard, or the like. The razor blade holder 206 further includes a slot 240 in which the razor blade is positioned. The razor blade is preferably removable and replaceable.

Yet another example of a handle 302 for a multipurpose tool is shown in FIG. 5. The handle 302 has a first end 308 and a second end 310 opposite of the first end 208. The handle 302 is made of a rigid material, such as metal, plastic, wood, or the like. The outer surface of the handle 302 is contoured for comfortable gripping. The handle 302 further includes an extendable member cavity 318 at the first end 308. The extendable member cavity 318 is sized and shaped to engage with an extendable member, similar to the extendable member 104 shown in FIGS. 1-3. A proximal end of the extendable member may be disposed in, and fixedly attached to, the extendable member cavity 318. At the second end 310 of the handle 302 is a razor blade holder 306 for a recessed blade film cutter. The razor blade holder 306 includes a channel 332 that exposes the razor blade when a razor blade is disposed in the holder 306. The razor blade holder 306 further includes a pointed tip 334 for piercing material, while the recessed razor blade disposed within the channel 332 cuts the material. The material may be shrink wrap, plastic pallet strapping, corrugated cardboard, or the like. The razor blade holder 306 is preferably configured so that the razor blade disposed therein can be removed and replaced. The handle 302 also includes an opening 342 configured for engaging with a hook, carabiner, or the like, for storage of the multipurpose tool.

### Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and Bis false (or not present), A is false (or not present) and Bis true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for creating an interactive message through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A multipurpose tool comprising:
a handle having a first end and a second end opposite of the first end, wherein the handle is sized and shaped to fit in a hand of a user;
a safety cutter disposed in the second end of the handle; and
an extendable member protruding from the first end of the handle, wherein the extendable member has an extended configuration and a collapsed configuration,
wherein the tool is sized and shaped to fit within a pocket in an article of clothing when the extendable member is in the collapsed configuration.

2. The multipurpose tool of claim 1, wherein the safety cutter comprises a razor blade and a cutting channel in the handle that exposes the razor blade.

3. The multipurpose tool of claim 2, wherein the cutting channel comprises a pointed end configured for piercing material.

4. The multipurpose tool of claim 1, wherein the extendable member comprises a plurality of telescoping parts and a locking mechanism for locking the telescoping parts in the extended configuration.

5. The multipurpose tool of claim 1, wherein the extendable member comprises a proximal end coupled to the handle and a distal end opposite of the proximal end, wherein the distal end comprises a hook or an L-shaped member.
